(19) United States
(12) Patent Application Publication
(10) Pub. No.: US 2025/0095909 A1
(43) Pub. Date: Mar. 20, 2025

(54) VERTICALLY-WOUND INDUCTOR AND METHOD FOR FABRICATING THE SAME

(71) Applicant: CHILISIN ELECTRONICS CORP., TAOYUAN CITY (TW)

(72) Inventors: SHU-PU YANG, TAOYUAN CITY (TW); SHOU-YI TSAO, TAOYUAN CITY (TW); WEN-HUI CHANG, TAOYUAN CITY (TW)

(21) Appl. No.: 18/885,824

(22) Filed: Sep. 16, 2024

(30) Foreign Application Priority Data
Sep. 18, 2023 (TW) 112135426

(51) Int. Cl. H01F 27/29; H01F 27/24; H01F 27/28

(52) U.S. Cl. CPC H01F 27/29; H01F 27/24; H01F 27/2804

(57) ABSTRACT

A vertically-wound inductor and a method for fabricating the same are provided. The vertically-wound inductor includes an inductor body, a coil, a first external electrode, a second external electrode and an intermediate layer. The coil includes a first coil portion and a second coil portion that are arranged opposite to each other and have a first gap therebetween. The first external electrode and the second external electrode are arranged on an outer surface of the inductor body, the first external electrode is connected to the first coil portion, and the second external electrode is connected to the second coil portion. The intermediate layer is located in the first gap and has a through hole. The first coil portion is connected to the second coil portion, and a direction of a central magnetic field is parallel to an arrangement direction of the first and second external electrodes.

### CROSS-REFERENCE TO RELATED PATENT APPLICATION

This application claims the benefit of priority to Taiwan Patent Application No. 112135426, filed on Sep. 18, 2023. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an inductor and a method for fabricating the same, and more particularly to a vertically-wound inductor and a method for fabricating the same.

### BACKGROUND OF THE DISCLOSURE

In an existing vertically-wound inductor, a curved structure is utilized when leading out from a coil to electrodes according to a structure of the inductors and a configuration of the electrodes. In other words, a connecting part that extends from the coil along a radial direction of a ring of the coil is usually designed to connect with the electrodes. However, such a curved structure makes the connecting part appear concave relative to the electrodes or a surface of the inductor. Therefore, weak spots will inevitably emerge as internal stress acts within the overall structure of the inductor. In this situation, using a press-forming process may easily lead to risks in quality of the product, such as from internal damage to the electrodes.

Therefore, improving a structural design to make the vertically-wound inductor applicable to the press-forming process has become one of the important issues in the relevant art.

### SUMMARY OF THE DISCLOSURE

In response to the above-referenced technical inadequacies, the present disclosure provides a vertically-wound inductor capable of improving a structural strength and being applicable to a thermal pressing process and a method for fabricating the same.

In order to solve the above-mentioned problems, one of the technical aspects adopted by the present disclosure is to provide a vertically-wound inductor, which includes an inductor body, a coil, a first external electrode, a second external electrode and an intermediate layer. The inductor body is made of a first magnetic material. The coil includes a first coil portion and a second coil portion that are disposed in the inductor body and opposite to each other, and a first gap is formed between the first coil portion and the second coil portion. The first external electrode and the second external electrode are arranged on an outer surface of the inductor body, the first external electrode is connected to the first coil portion, and the second external electrode is connected to the second coil portion. The intermediate layer is disposed in the inductor body and located in the first gap, and the intermediate layer is provided with a through hole. The first coil portion is connected to the second coil portion through a connecting part penetrating the through hole, and a direction of a central magnetic field generated by the coil is parallel to an arrangement direction of the first external electrode and the second external electrode.

In order to solve the above-mentioned problems, another one of the technical aspects adopted by the present disclosure is to provide a method for fabricating a vertically-wound inductor, and the method includes: providing a substrate, and performing a drilling process on the substrate to form at least one through hole; performing a photolithography process to form a first coil portion and a second coil portion on both sides of the substrate, wherein a connecting portion is formed to penetrate the at least one through hole and connects the first coil portion to the second coil portion, and a first gap is formed between the first coil portion and the second coil portion; performing a first cutting process on the substrate, the first coil portion and the second coil portion to form a coil including the first coil portion and the second coil portion, and forming an intermediate layer in the first gap; placing the coil and the intermediate layer into a mold and filling a first magnetic material into the mold to form an inductor body by performing a pressing process; performing a cutting process on the inductor body to expose a part of each of the first coil portion and the second coil portion; and performing an electroplating process to form a first external electrode and a second external electrode on an outer surface of the inductor body. The first external electrode is connected to the first coil portion, and the second external electrode is connected to the second coil portion. The direction of a central magnetic field generated by the coil is parallel to an arrangement direction of the first external electrode and the second external electrode.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a three-dimensional schematic view of a vertically-wound inductor according to one embodiment of the present disclosure;

FIG. 2 is a schematic side view of the vertically-wound inductor according to one embodiment of the present disclosure;

FIG. 3 is a schematic front view of the vertically-wound inductor according to one embodiment of the present disclosure;

FIG. 4 is a schematic top view of a first coil portion according to one embodiment of the present disclosure;

FIG. 5 is a schematic top view of a second coil portion according to one embodiment of the present disclosure;

FIG. 6 is a schematic top view of an intermediate layer according to one embodiment of the present disclosure;

FIG. 7 is a flowchart of a method for fabricating the vertically-wound inductor according to one embodiment of the present disclosure;

FIG. 8 is a schematic diagram of a step of forming a through hole in step S10;

FIG. 9 is a schematic diagram of a step of forming a predetermined pattern layer in step S11;

FIG. 10 is a schematic diagram of a step of forming a to-be-formed coil portion in step S11;

FIG. 11 is a schematic diagram showing a step of placing a formed coil and the intermediate layer into a mold to perform a pressing process in step S13;

FIG. 12 is a schematic diagram showing a step of performing a cutting process to form an inductor body in step S14;

FIG. 13 is a schematic diagram of a step of performing an electroplating process to form a first external electrode and a second external electrode in step S15;

FIG. 14 is a three-dimensional schematic view of a vertically-wound inductor according to another one embodiment of the present disclosure;

FIG. 15 is a first three-dimensional schematic view of a coil, a first external electrode and a second external electrode according to another one embodiment of the present disclosure;

FIG. 16 is a second first three-dimensional schematic view of the coil, the first external electrode and the second external electrode according to the another one embodiment of the present disclosure; and

FIG. 17 is an exploded three-dimensional schematic view of the coil, the first external electrode and the second external electrode according to the another one embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

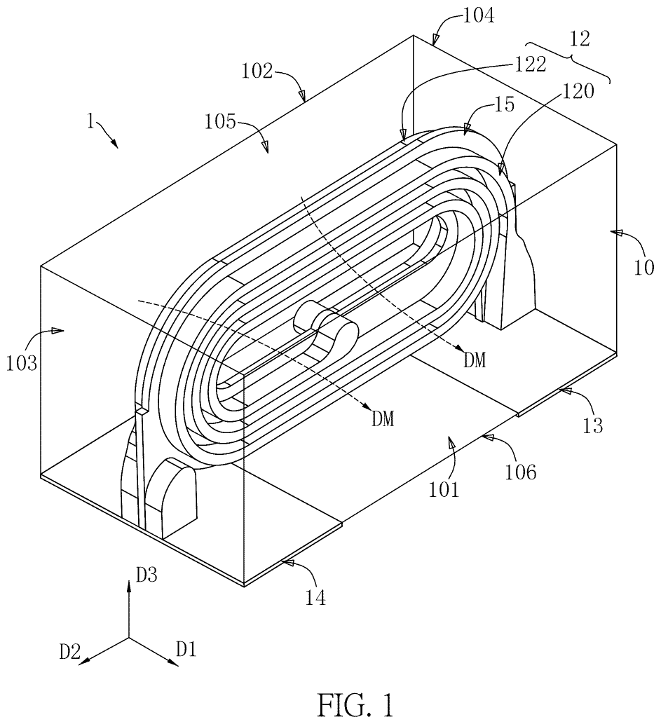

Referring to FIGS. 1 to 5, one embodiment of the present disclosure provides a vertically-wound inductor, which includes an inductor body 10, a coil 12, a first external electrode 13, a second external electrode 14 and an intermediate layer 15.

The inductor body 10 is formed to be provided with an appearance as shown in FIGS. 1 to 3 and is made of a first magnetic material. In addition, the inductor body 10 can optionally include a binder material. The inductor body 10 can be formed by filling magnetic powder made of the first magnetic material and other components of the vertically-wound inductor 1 into a mold and then pressing. In order to clearly show an internal structure of the vertically-wound inductor 1, the inductor body 10 is made transparent in FIGS. 1 to 3.

The coil 12 can include a first coil portion 120 and a second coil portion 122 that can be oppositely disposed in the inductor body 10, and a first gap G1 can be defined between the first coil portion 120 and the second coil portion 122. The inductor body 10 can be a hexahedron having a first surface 101 and a second surface 102 opposite to each other in a first direction D1, a third surface 103 and a fourth surface 104 opposite to each other in a second direction D2, and a fifth surface 105 and a sixth surface 106 opposite to each other in a third direction D3. When the vertically-wound inductor 1 is mounted on a printed circuit board, the sixth surface 106 of the inductor body 10 can be used as a mounting surface.

The first external electrode 13 and the second external electrode 14 can be, for example, conductive metal plates, and are disposed on an outer surface of the inductor body 10, for example, on the sixth surface 106. The first external electrode 13 is connected to the first coil portion 120, and the second external electrode 14 is connected to the second coil portion 122. Both the first external electrode 13 and the second external electrode 14 extend along the first direction D1; therefore, the first direction D1 is hereinafter referred to as an arrangement direction of the first external electrode 13 and the second external electrode 14. As shown in FIG. 1, although lengths of the first external electrode 13 and the second external electrode 14 in the first direction D1 are the same as the length of the inductor body 10 in the first direction D1, the present disclosure is not limited thereto.

The intermediate layer 15 is disposed in the inductor body 10 and is located in the first gap G1. As shown in FIG. 1 to FIG. 3, the first coil portion 120, the intermediate layer 15, and the second coil portion 122 can be sequentially arranged along the first direction D1. The intermediate layer 15 can be made of, for example, a non-conductive material, and can have a similar morphology to the first coil portion 120 and the second coil portion 122. The non-conductive material can include at least one of an organic material containing oxygen and silicon functional groups, an epoxy resin, a polyimide (PI), a glass fiber material, and a ceramic material. It should be noted that, in order to connect the first coil portion 120 and the second coil portion 122 to each other, the intermediate layer 15 is provided with a through hole 150, so as to reserve a path for connecting the first coil portion 120 and the second coil portion 122 to each other.

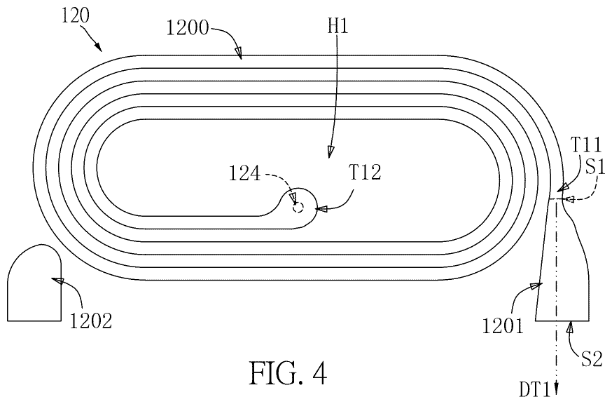

The details of the first coil portion 120 and the second coil portion 122 are described in detail hereinafter. FIG. 4 is a schematic top view of a first coil portion according to one embodiment of the present disclosure. Referring to FIG. 4, the first coil portion 120 can be, for example, a coil formed by spirally winding a conductive metal rectangular wire in a counterclockwise direction, but the present disclosure is not limited thereto, and the first coil portion 120 can also be formed by spirally winding a metal round wire. The first coil portion 120 includes a first coil pattern 1200 and a first connecting pattern 1201, and the first coil pattern 1200 is electrically connected to the first external electrode 13 through the first connecting pattern 1201.

In this embodiment, the first coil pattern 1200 is a first vortex coil formed from outside to inside along a counterclockwise direction. The first vortex coil can be composed of two semicircles and a rectangle, and has a first hollow portion H1. The first connecting pattern 1201 extends along a first tangential direction DT1 formed by a first end T11 of the first vortex coil to connect the first end T11 to the first external electrode 13. In addition, the first coil pattern 1200 further has a second end T12 located at a center of the first vortex coil, on which a connecting part 124 penetrating the through hole 150 of the intermediate layer 15 is disposed, such that the first coil portion 120 can be connected to the second coil portion 122.

In some embodiments, the first connecting pattern 1201 can have a gradual structure. Specifically, a first connecting surface S1 is formed at a position (i.e., the first end T11) where the gradual structure and the first coil pattern 1200 are connected, a second connecting surface S2 is formed at a position where the gradual structure and the first external electrode 13 are connected, and an area of the first connecting surface S1 is smaller than an area of the second connecting surface S2. Therefore, as can be seen from FIG. 4, the first connecting pattern 1201 can have a trapezoidal column structure, and this design of being wider at the bottom and narrower at the top can provide better stability for the first coil portion 120.

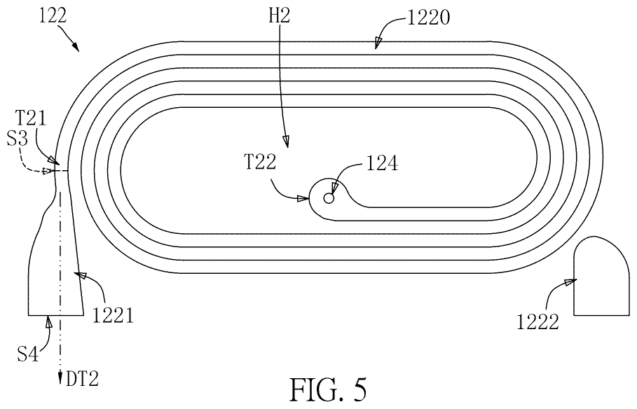

FIG. 5 is a schematic top view of a second coil portion according to one embodiment of the present disclosure. Referring to FIG. 5, similar to the first coil portion 120, the second coil portion 122 can also be a coil formed by spirally winding a metal rectangular wire in a clockwise direction, that is, the first coil portion 120 and the second coil portion 122 can be symmetrically arranged with the intermediate layer 15 as a center plane.

The second coil portion 122 includes a second coil pattern 1220 and a second connecting pattern 1221, and the second coil pattern 1220 is electrically connected to the second external electrode 14 through the second connecting pattern 1221.

In this embodiment, the second coil pattern 1200 is a second vortex coil formed from the outside to the inside along the clockwise direction. Similar to the first vortex coil, the second vortex coil also has a second hollow portion H2, and the second connecting pattern 1221 extends along a second tangential direction DT2 formed by a first end T21 of the second vortex coil to connect the first end T21 to the second external electrode 14. In addition, the second coil pattern 1220 further has a second end T2 located at the center of the second vortex coil, on which a connecting part 124 penetrating the through hole 150 of the intermediate layer 15 is disposed, such that the second coil portion 122 can be connected to the first coil portion 120.

The second connecting pattern 1221 also has a gradual structure. Specifically, a third connecting surface S3 is formed at a position (i.e., the first end T21) where the gradual structure and the second coil pattern 1200 are connected, a fourth connecting surface S4 is formed at a position where the gradual structure and the second external electrode 13 are connected, and an area of the third connecting surface S3 is smaller than an area of the fourth connecting surface S4. Therefore, as can be seen from FIG. 5, the second connecting pattern 1201 can have a trapezoidal column structure, and a design of being wider at the bottom and narrower at the top can provide better stability for the second coil portion 122.

Since the first coil pattern 1200 has one end extending along the first tangential direction DT1 of an outermost circle of the first vertex coil and the second coil pattern 1220 has one end extending along the second tangential direction DT2 of an outermost circle of the second vertex coil, the first tangential direction DT1 can be parallel to the second tangential direction DT2. In addition, the first tangential direction DT1 and the second tangential direction DT2 are perpendicular to an outer surface of the inductor body 10 for forming the first external electrode 13 and the second external electrode 14 (i.e., the sixth surface 106). In other words, since the first external electrode 13 and the second external electrode 14 can be led out in a straight line through the first connecting pattern 1201 and the second connecting pattern 1221, connections among the connecting pattern, the coil pattern and the external electrode will have greater structural strength, thereby avoiding quality issues such as deformation or displacement of the first coil pattern 1200 and the second coil pattern 1220, or even internal damage from cracks that may have been formed during the thermal pressing process.

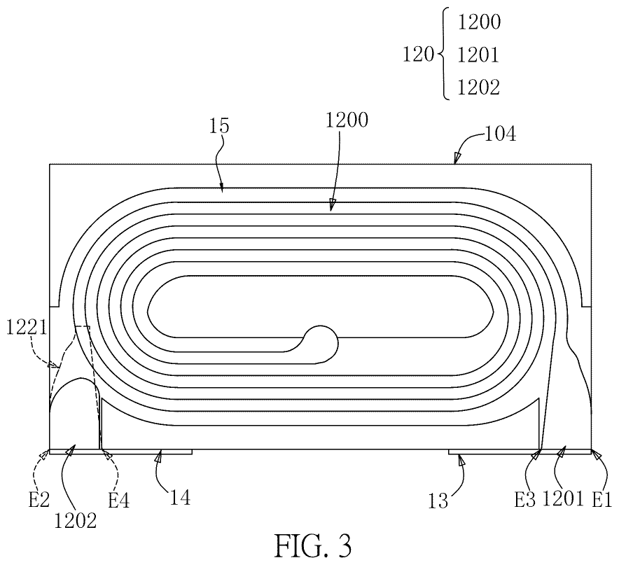

In addition, as can be observed from FIG. 3, although the first connecting pattern 1201 and the second connecting pattern 1221 are located at edges of the first external electrode 13 and the second external electrode 14, respectively, the present disclosure is not limited thereto. Referring to FIG. 1, a position of the first connecting pattern 1201 can be adjusted along the second direction D2 toward the second external electrode 14. As shown in FIG. 3, an outer edge E1 of the first connecting pattern 1201 and the rightmost edge of the sixth surface 106 are spaced apart by a first predetermined length. Similarly, a position of the second connecting pattern 1221 can be adjusted along the second direction D2 toward the first external electrode 13. As can be seen from FIG. 3, an outer edge E2 of the second connecting pattern 1221 and the leftmost edge of the sixth surface 106 can be spaced apart by a second predetermined length. In some embodiments, the first predetermined length and the second predetermined length can range from 10 μm to 500 μm.

However, it should be noted that for designs of the inductor body 10 with different sizes, the first external electrode 13 and the second external electrode 14 can have different predetermined widths in the second direction D2, and the first predetermined length and the second predetermined length can be adjusted accordingly. In one preferred embodiment, the first predetermined length and the second predetermined length can range from 0% to 50% of the predetermined width, and the inner edge E3 of the first connecting pattern 1201 and the inner edge E4 of the second connecting pattern 1221 can be adjusted according to a size of an outer diameter of the coil of the first coil pattern 1200 and the second coil pattern 1220, respectively.

Therefore, it can be ensured that the coil 12 (especially peripheral areas of the first connecting pattern 1201 and the second connecting pattern 1221) will not crack due to internal stress during the process (for example, the thermal pressing process).

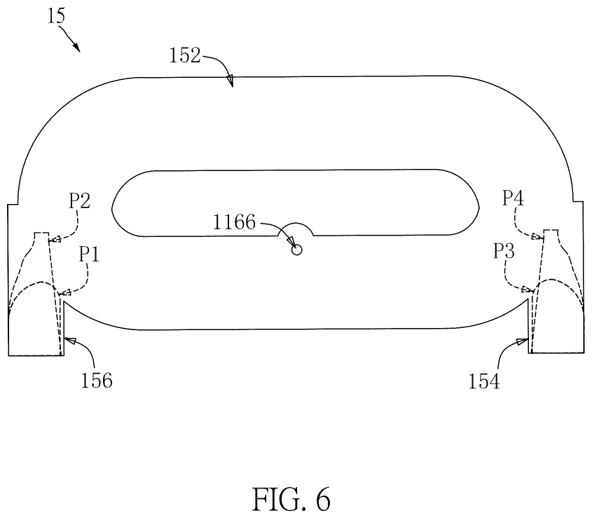

FIG. 6 is a schematic top view of an intermediate layer according to one embodiment of the present disclosure. Referring to FIG. 6, the intermediate layer 15 is parallel to the first coil portion 120 and the second coil portion 122 along the first direction D1 and is disposed in the first gap G1. A thickness of the intermediate layer 15 is related to a length of the first gap G1 and can be used to adjust inductance characteristics (e.g., inductance) of the coil 12. The intermediate layer 15 can be a plate. In terms of morphology, the intermediate layer 15 has an enclosed ring 152 similar to the first vortex coil and the second vortex coil. The enclosed ring 152 has a hollow portion H3 corresponding to the first hollow portion H1 and the second hollow portion H2, and also has an area that can completely cover the first vortex coil and the second vortex coil.

In addition, the enclosed ring 152 is connected to the first external electrode 13 and the second external electrode 14 through extending portions 154 and 156, respectively. The extending portion 154 extends along the first tangential direction DT1 and is attached to the first connecting pattern 1201, while the extending portion 156 extends along the second tangential direction DT2 and is attached to the second connecting pattern 1121, thereby enhancing a structural strength of the coil 12 to prevent the coil 12 from being collapsed or damaged due to external forces during the manufacturing process.

Referring to FIGS. 4 to 6, the first coil portion 120 further includes a first dummy connecting pattern 1202 connected to the second external electrode 14, and the second coil portion 122 further includes a second dummy connecting pattern 1222 connected to the first external electrode 13. The first dummy connecting pattern 1202 corresponds to the second connecting pattern 1221 in both position and shape, and the second dummy connecting pattern 1222 corresponds to the first connecting pattern 1201 in both position and shape.

The first dummy connecting pattern 1202 can be made of the same material and thickness as the first coil pattern 1200, but the present disclosure is not limited thereto. In addition, in terms of position, as shown in FIG. 6, a first vertical projection P1 formed by the first dummy connecting pattern 1202 onto the intermediate layer 15 overlaps with a second vertical projection P2 formed by the second connecting pattern 1221 on the intermediate layer 15, and a third vertical projection P3 formed by the second dummy connecting pattern 1222 onto the intermediate layer 15 overlaps with a fourth vertical projection P4 formed by the first dummy connecting pattern 1201 on the intermediate layer 15.

It should be noted that the first dummy connecting pattern 1202 is not directly connected to the first coil pattern 1200, and is arranged on a side of the first vortex coil that is not connected to the first dummy connecting pattern 1201, so as to contact the second external electrode 14 and the extending portion 156, thereby providing support for the intermediate layer 15 in the first direction D1 to enhance a structural strength of the intermediate layer 15 at a position where the extending portion 156 is located.

Similarly, the second dummy connecting pattern 1222 is not directly connected to the second coil pattern 1220, and is arranged on a side of the second vortex coil that is not connected to the second connecting pattern 1221, so as to contact the first external electrode 13 and the extending portion 154, thereby providing support for the middle layer 15 in the first direction D1 to enhance the structural strength of the intermediate layer 15 at a position where the extending portion 154 is located.

Referring to FIG. 1 again, when the vertically-wound inductor 1 is energized, a magnetic field is generated at a center of the coil 12 (referred to as a central magnetic field) after the first coil portion 120 and the second coil portion 122 are energized. A direction DM of the central magnetic field is parallel to the arrangement direction (i.e., the first direction D1) of the first external electrode 13 and the second external electrode 14. Compared with the situation in which the central magnetic field is perpendicular to the arrangement direction of the electrodes in a conventional inductor, since the central magnetic field of the vertically-wound inductor 1 is parallel to the arrangement direction, the central magnetic field generated by a current along the third direction D3 at the external electrodes can reduce interferences that occur when the vertically-wound inductor 1 is used.

It should be further explained that, although in the above embodiments that the first external electrode 13 and the second external electrode 14 are two plates and are only arranged on the sixth surface 106 of the inductor body 10 (i.e., the bottom of the inductor body 10), the present disclosure is not limited thereto. The first external electrode 13 and the second external electrode 14 can also be led out from a side of the inductor body 10. For example, the first external electrode 13 and the second external electrode 14 can be designed as L-shaped plates, thereby further leading the first external electrode 13 and the second external electrode 14 on one or more of the first surface 101, the second surface 102, the third surface 103 and the fourth surface 104 according to needs, and providing electrical contacts connected to external circuits.

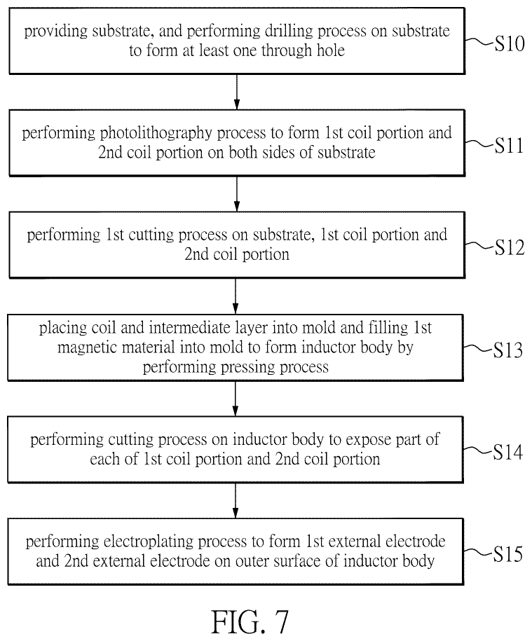

Reference is made to FIG. 7, which is a flowchart of a method for fabricating the vertically-wound inductor according to one embodiment of the present disclosure. In one embodiment of the present disclosure, a method for fabricating a vertically-wound inductor is also provided, and the method can be used to manufacture the vertically-wound inductor 1 as shown in FIG. 1 and include the following steps:

Step S10: providing a substrate, and performing a drilling process on the substrate to form at least one through hole.

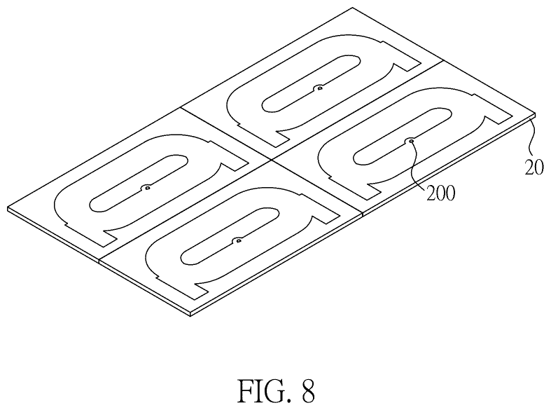

FIG. 8 is a schematic diagram of a step of forming a through hole in step S10. In step S10, the drilling process is performed on the substrate 20 according to a quantity of the vertically-wound inductor 1 to be formed, and the substrate 20 will be used to form the intermediate layer 15 mentioned above in the subsequent steps, as shown in patterns on the substrate 20 in FIG. 8, but the patterns are for illustration purposes only. Therefore, the through hole 200 is disposed at a position corresponding to the through hole 150 in the intermediate layer 15, and the through hole 200 can be further used to form the connecting part 124 at the center of the coil 12 in subsequent processes. It should be noted that in order to ensure that a certain supporting force and structural strength can be provided in the subsequent pressing process, the substrate 20 can be, for example, a non-conductive material, including at least one of an organic material containing oxygen and silicon functional groups, an epoxy resin, a polyimide (PI), a glass fiber material, and a ceramic material. The substrate 20 can have a thickness greater than 20 μm, which also corresponds to the thickness of the intermediate layer 15 formed subsequently.

Step S11: performing a photolithography process to form a first coil portion and a second coil portion on both sides of the substrate.

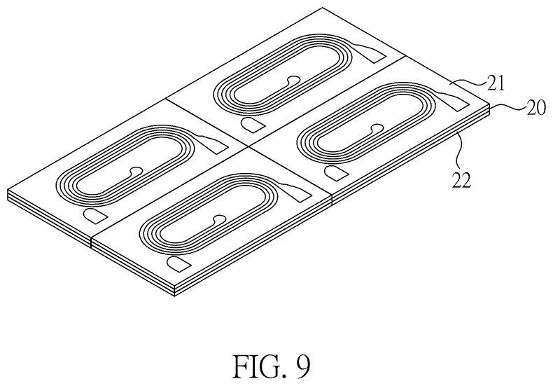

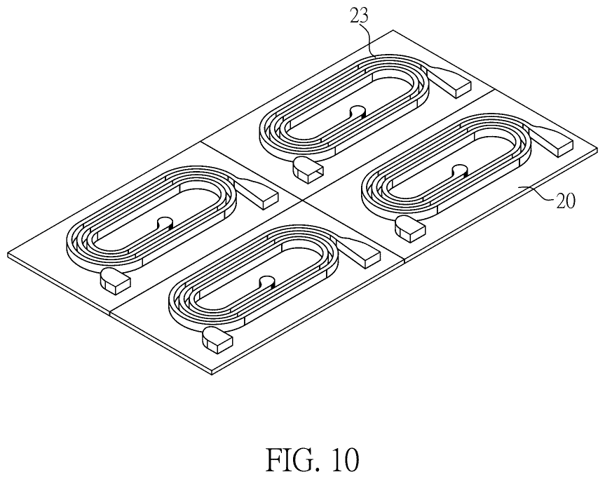

For example, reference can be made to FIG. 9, which is a schematic diagram of a step of forming a predetermined pattern layer in step S11. In step S11, a lithography processes can be performed on both sides of the substrate 20 to form a first predetermined pattern layer 21 and a second predetermined pattern layer 22, respectively. Next, a to-be-formed coil portion 23 is formed on the first predetermined pattern layer 21 through a deposition process. Similarly, another to-be-formed coil portion (not shown) having a morphology similar to the to-be-formed coil portion 23 can be formed on the second predetermined pattern layer 22. Finally, the first predetermined pattern layer 21 and the second predetermined pattern layer 22 can be removed by an etching process, leaving only the to-be-formed coil portion 23 on the substrate 20, as shown in FIG. 10, which is a schematic diagram of a step of forming a to-be-formed coil portion in step S11. The to-be-formed coil portion 23 can be used to form the first coil portion 120 and the second coil portion 122 mentioned in the above embodiments.

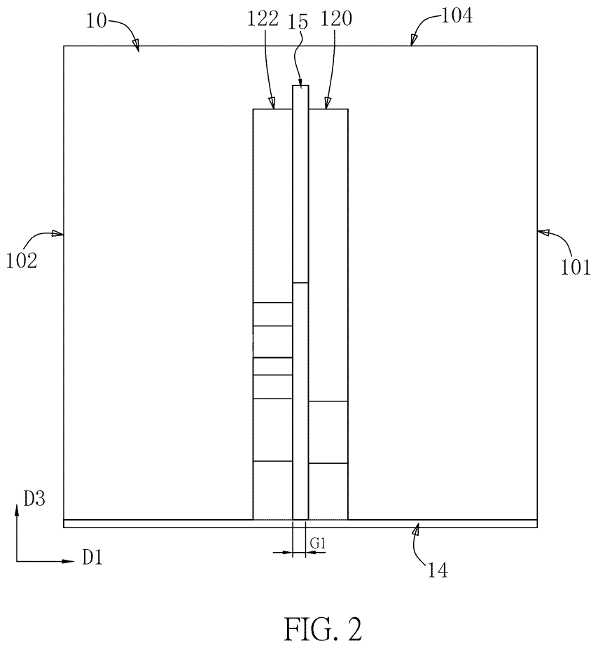

During the deposition process, a connecting part 124 is deposited in the through hole 200 to connect the first coil portion 120 to the second coil portion 122. Since the first coil portion 120 to the second coil portion 122 are separated by the substrate 10, a first gap G1 can be defined between the first coil portion 120 and the second coil portion 122 (see FIG. 2).

Step S12: performing a first cutting process on the substrate, the first coil portion and the second coil portion.

Step S13: placing the coil and the intermediate layer into a mold and filling a first magnetic material into the mold to form an inductor body by performing a pressing process.

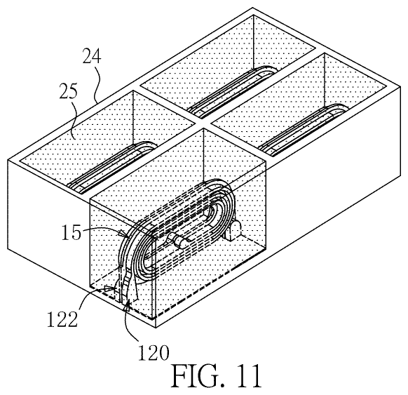

FIG. 11 is a schematic diagram showing a step of placing a formed coil and the intermediate layer into a mold to perform a pressing process in step S13. Referring to FIGS. 1, 6 and 11, in step S12, the substrate 20 can be cut according to the intermediate layer 15 to be formed in FIG. 6 to form a coil 12 including a first coil portion 120 and a second coil portion 122 as shown in FIG. 1, and the intermediate layer 15 is formed in the first gap G1.

Next, as shown in FIG. 11, the mold 24 is filled with corresponding magnetic powder 25, which can be, for example, alloy materials having a particle size distribution D50 (a particle size corresponding to a cumulative particle size distribution percentage reaching 50%) less than 10 μm, such as iron, silicon, chromium, nickel and/or aluminum, amorphous conductor materials, nanocrystals, or carbon-based iron powder or alloy materials with a particle size distribution D50 of more than 10 μm. The intermediate layer 15 for arranging in the first gap G1 can be formed by pressing.

It is worth mentioning that the pressing process can be a thermal pressing process, a thermal pressing temperature that is used can range from 100 degrees to 200 degrees, and a pressure that is used can range from 10 MPa to 600 MPa. Outside of such temperature and pressure ranges, the inductor may not be formed.

In addition, since the first external electrode 13 and the second external electrode 14 can be led out in a straight line through the first connecting pattern 1201 and the second connecting pattern 1221, the connections among the connection pattern, the coil pattern and the external electrode will have greater structural strength, thereby avoiding quality issues such as deformation or displacement of the first coil pattern 1200 and the second coil pattern 1220, or even internal damage from cracks that may have been formed during the thermal pressing process.

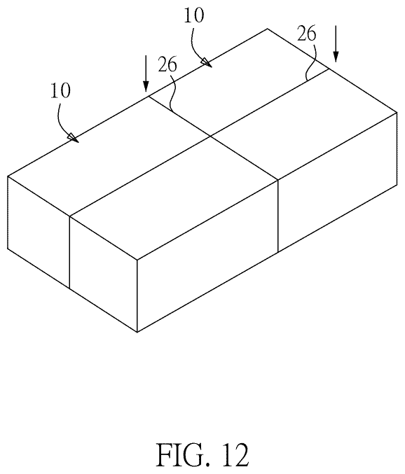

Step S14: performing a cutting process on the inductor body to expose a part of each of the first coil portion and the second coil portion. FIG. 12 is a schematic diagram showing a step of performing a cutting process to form an inductor body in step S14. As shown in FIG. 12, the pressed inductor body 10 can be cut along cutting lines 26 to expose parts intended for connecting the external electrodes, that is, parts of the first connecting pattern 1201, the second connecting pattern 1221, the first dummy connecting pattern 1202 and the second dummy connecting pattern 1222 facing the sixth surface 106.

Step S15: performing an electroplating process to form a first external electrode and a second external electrode on an outer surface of the inductor body.

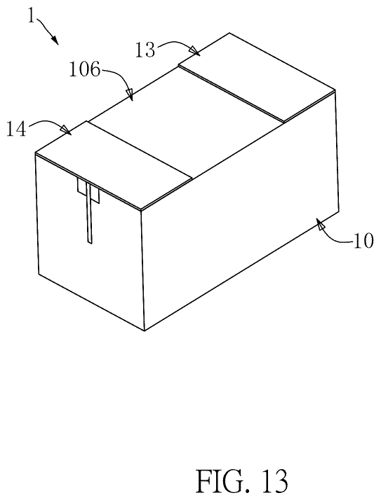

FIG. 13 is a schematic diagram of a step of performing an electroplating process to form a first external electrode and a second external electrode in step S15. As shown in FIG. 13, the first external electrode 13 and the second external electrode 14 can be formed on the sixth surface 106 to form the vertically-wound inductor 1.

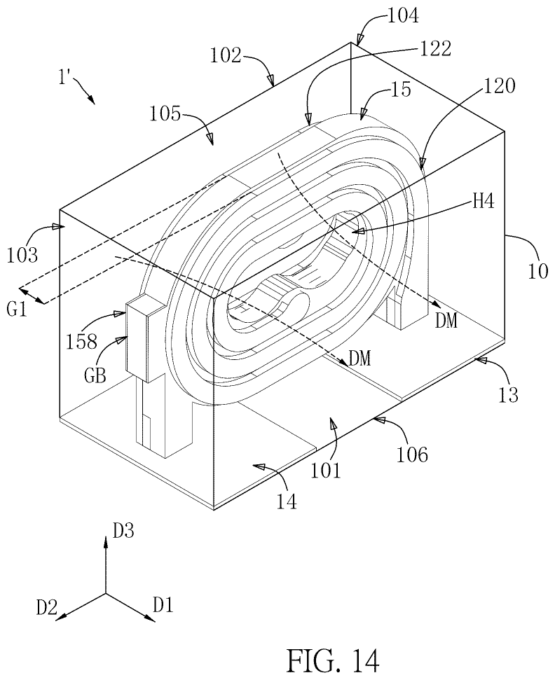

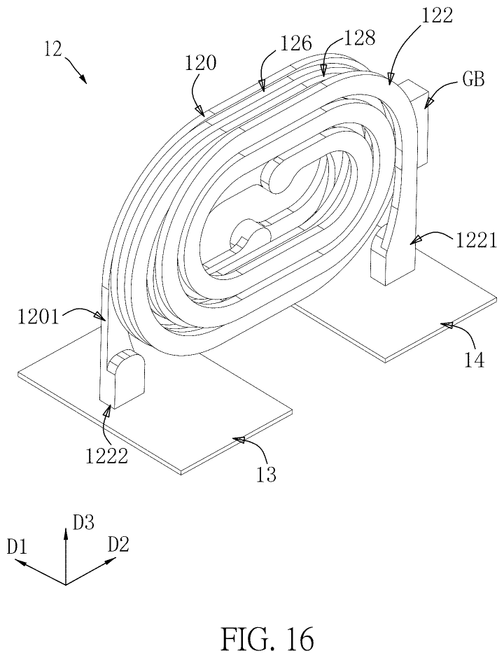

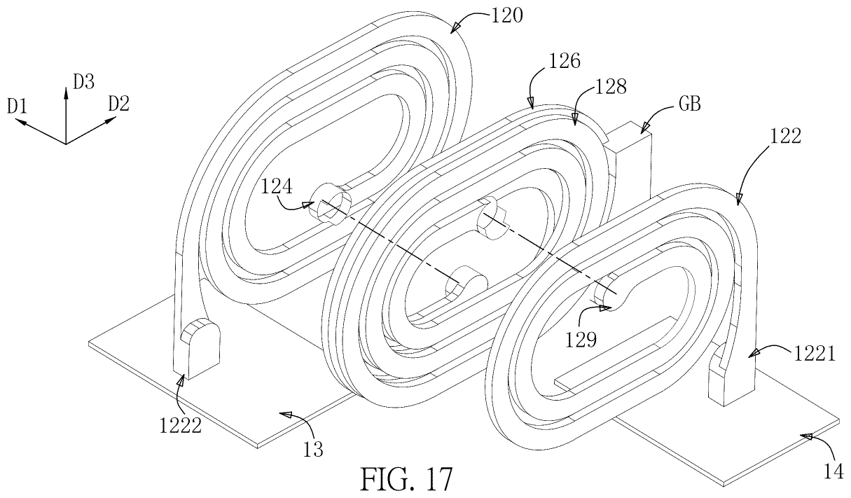

Referring to FIGS. 14 to 17, another one embodiment of the present disclosure provides a vertically-wound inductor 1′, which includes an inductor body 10, a coil 12, a first external electrode 13, a second external electrode 14 and an intermediate layer 15. The vertically-wound inductor 1′ is similar to the vertically-wound inductor 1, thus repeated descriptions are omitted hereinafter.

The coil 12 can include a first coil portion 120 and a second coil portion 122 that can be oppositely disposed in the inductor body 10, and a first gap G1 can be defined between the first coil portion 120 and the second coil portion 122.

Different form the vertically-wound inductor 1, the coil 12 of the vertically-wound inductor 1′ further includes at least one third coil portion 124 and at least one fourth coil portion 128 disposed between the first coil portion 120 and the second coil portion 122, more specifically, the at least one third coil portion 126 and the at least one fourth coil portion 128 can be disposed between the first gap G1 and are opposite to one another, so as to further adjust inductance characteristics (e.g., inductance) of the coil 12. The second gap G2 is formed between the at least one third coil portion 126 and the at least one fourth coil portion 128. Each of the at least one third coil portion 126 and the at least one fourth coil portion 128 can be patterned as a vortex coil that is similar to the vortex coils of the first coil pattern 1200 and the second coil pattern 1220.

The intermediate layer 15 has an enclosed ring that completely covers the vortex coils of the first coil portion 120, the second coil portion 122, the third coil portion 126 and the fourth coil portion 128 along the first direction D1.

It should be noted that the number of the third coil portion 126 can be one or more, the number of the fourth coil portion 128 can also be one or more, and the numbers of the third coil portion 126 and the fourth coil portion 128 are proportional to the inductance of the coil 12. In FIGS. 14 to 17, the coil 12 including one third coil portion 126 and one fourth coil portion 128 is taken as an example, the third coil portion 126 and the fourth coil portion 128 can be connected through a guide bonding portion GB disposed at a side of the coil 12, such as the leftmost side of the coil 12 along the second direction D2 when being viewed from a front side of the inductor body 10. The guide bonding portion GB can be made of conductive metal materials as the same as those of the first coil portion 120, the second coil portion 122, the third coil portion 124 and the fourth coil portion 126. The guide bonding portion GB can be a conductive metal block extending from a side of the third coil portion 126 and a side of the fourth coil portion 128, and contacts the third surface 103. One or more vias or through holes can be provided inside the guide bonding portion GB to form electrical connections between the third coil portion 124 and the fourth coil portion 126.

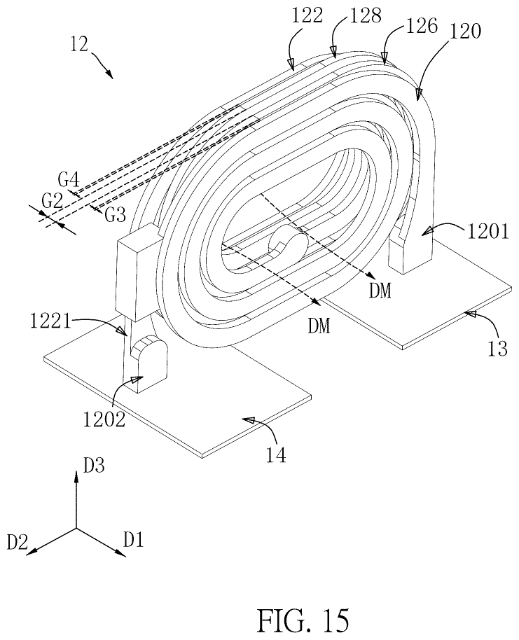

Furthermore, referring to FIGS. 14 and 15, the vortex coil of the first coil portion 120 is separated from the third coil portion 126 by a third gap G3, the vortex coil of the second coil portion 122 is separated from the fourth coil portion 128 by a fourth gap G4, and the third gap G3 and the fourth gap G4 can be filled by the intermediate layer 15. Moreover, the guide bonding portion GB does not contact any of the first coil portion 120 and the second coil portion 122 in order to avoid short circuits. It should be noted that the guide bonding portion GB is arranged based on Ampère's right-hand grip rule, such that the magnetic fields generated at centers of the vortex coils of the first coil portion 120, the second coil portion 122, the third coil portion 126 and the fourth coil portion 128 have the same directions, which are parallel to the arrangement direction DM of the first external electrode 13 and the second external electrode 14.

In other embodiments, the number of the guide bonding portion GB can be plural in a case that the number of the third coil portion 126 is more than one and the number of the fourth coil portion 128 is more than one. For example, in a case that the coil 12 including two third coil portions 126 and two fourth coil portions 128, three guide bonding portions GB can be utilized and disposed at different sides of the coil 12. One of the guide bonding portions GB is connected to the two third coil portions 126, another one of the guide bonding portions GB is connected to the third coil portions 126 and the fourth coil portion 128 that are disposed adjacent to each other, and the other of the guide bonding portions GB is connected to the two fourth coil portion 128. In this case, the guide bonding portions GB are also arranged based on Ampère's right-hand grip rule, such that the magnetic fields generated at centers of the vortex coils of the first coil portion 120, the second coil portion 122, the third coil portions 126 and the fourth coil portions 128 have the same directions, which are parallel to the arrangement direction DM of the first external electrode 13 and the second external electrode 14.

The intermediate layer 15 is disposed in the inductor body 10 and is located in the first gap G1. As shown in FIG. 14 to FIG. 17, the first coil portion 120, the intermediate layer 15, and the second coil portion 122 can be sequentially arranged along the first direction D1, and the first coil portion 120, the third coil portion 126, the fourth coil portion 128, and the second coil portion 122 can be sequentially arranged along the first direction D1. The intermediate layer 15 can be made of, for example, a non-conductive material, and can have a similar morphology to the third coil portion 126 and the fourth coil portion 128. The non-conductive material can include at least one of an organic material containing oxygen and silicon functional groups, an epoxy resin, a polyimide (PI), a glass fiber material, and a ceramic material. It should be noted that, in order to connect the first coil portion 120 and the second coil portion 122 to each other, the intermediate layer 15 is provided with two through hole (not shown), so as to reserve a path for connecting the first coil portion 120 to the third coil portion 126 and a path for connecting the second coil portion 122 to the fourth coil 128. Specifically, the first coil portion 120 can be connected to the third coil portion 126 through the connecting part 124 penetrating one of the through holes, the second coil portion 122 can be connected to the fourth coil portion 128 through another connecting part 129 penetrating the another through hole.

Different from the previous embodiments, the intermediate layer 15 has at least one protrusion portion 158 that is formed to surround the guide bonding portion GB. The number and morphology of the protrusion portion 158 basically correspond to the number and the morphology of the guide bonding portion GB.

Similar to the previous embodiments, each of the first coil pattern 1200 and the second coil pattern 1220 has the vortex coil that is composed of two semicircles and a rectangle, and has a hollow portion. Each of the third coil portion 126 and the fourth coil portion 128 are patterned as the vortex coil similar to those of the first coil pattern 1200 and the second coil pattern 1220.

Referring to FIG. 14, the intermediate layer 15 is disposed in the first gap G1. A thickness of the intermediate layer 15 is related to a length of the first gap G1 and thicknesses of the third coil portion 126 and the fourth coil portion 128. The thickness of the intermediate layer 15 can also be used to adjust inductance characteristics (e.g., inductance) of the coil 12. In terms of morphology, the intermediate layer 15 has an enclosed ring similar to the vortex coils of the first coil portion 120, the second coil portion 122, the third coil portion 126, and the fourth coil portion 128. The enclosed ring has a hollow part H4 corresponding to the hollow portions of the first coil portion 120, the second coil portion 122, the third coil portion 126.

Different from FIGS. 4 to 6, in the present embodiment, the first dummy connecting pattern 1202 of the first coil portion 120 is formed to contact the second connecting pattern 1221 of the second coil portion 122, and the second dummy connecting pattern 1222 of the second coil portion 122 is formed to contact the first connecting pattern 1201, thereby providing support for the first coil portion 120 and the second coil portion 122 in the first direction D1 to enhance the structural strength.

Referring to FIG. 14 again, when the vertically-wound inductor 1′ is energized, the magnetic field is generated at the center of the coil 12 (referred to as a central magnetic field) after the first coil portion 120 and the second coil portion 122 are energized. The direction DM of the central magnetic field is parallel to the arrangement direction (i.e., the first direction D1) of the first external electrode 13 and the second external electrode 14. Compared with the situation in which the central magnetic field is perpendicular to the arrangement direction of the electrodes in a conventional inductor, since the central magnetic field of the vertically-wound inductor 1′ is parallel to the arrangement direction, the central magnetic field generated by a current along the third direction D3 at the external electrodes can reduce interferences that occur when the vertically-wound inductor 1′ is used.

### Beneficial Effects of the Embodiments

In conclusion, in the vertically-wound inductor and the method for fabricating the same provided by the present disclosure, since the first external electrode and the second external electrode are led out in the straight line through the first connecting pattern and the second connecting pattern, the connections among the connecting pattern, the coil pattern and the external electrode will have greater structural strength, thereby avoiding quality issues such as deformation or displacement of the first coil pattern and the second coil pattern, or even internal damage from cracks that may have been formed during the thermal pressing process.

Furthermore, in the vertically-wound inductor and the method for fabricating the same provided by the present disclosure, the direction of the central magnetic field generated in the center of the coil after the first coil portion and the second coil portion are energized is parallel to the arrangement direction of the first external electrode and the second external electrode. Compared with the central magnetic field generated in a conventional inductor, interferences that occur when the vertically-wound inductor 1 is used can be reduced.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A vertically-wound inductor, comprising:
an inductor body made of a first magnetic material;
a coil including a first coil portion and a second coil portion, wherein the first coil portion and the second coil portion are disposed in the inductor body and are opposite to each other, and a first gap is formed between the first coil portion and the second coil portion;
a first external electrode and a second external electrode disposed on an outer surface of the inductor body, wherein the first external electrode is connected to the first coil portion, and the second external electrode is connected to the second coil portion; and
an intermediate layer disposed in the inductor body and located in the first gap, wherein the intermediate layer is provided with a through hole;
wherein the first coil portion is electrically connected to the second coil portion through a connecting part penetrating the through hole, and a direction of a central magnetic field generated by the coil is parallel to an arrangement direction of the first external electrode and the second external electrode.

2. The vertically-wound inductor according to claim 1, wherein the first coil portion includes a first coil pattern and a first connecting pattern, and the first coil pattern is electrically connected to the first external electrode through the first connecting pattern,
wherein the second coil portion includes a second coil pattern and a second connecting pattern, and the second coil pattern is electrically connected to the second external electrode through the second connecting pattern.

3. The vertically-wound inductor according to claim 2, wherein the first coil pattern is a first vortex coil, and the first connecting pattern extends along a first tangential direction formed by a first end of the first vortex coil to connect the first end of the first vortex coil to the first external electrode;
wherein the second coil pattern is a second vortex coil, and the second connecting pattern extends along a second tangential direction formed by a first end of the second vortex coil to connect the first end of the second vortex coil to the second external electrode, and a second end of the first vortex coil is connected to a second end of the second vortex coil through the connecting part.

4. The vertically-wound inductor according to claim 3, wherein the first connecting pattern has a first gradual structure, a first connecting surface is formed at a position where the first gradual structure and the first coil pattern are connected, a second connecting surface is formed at a position where the first gradual structure and the first external electrode are connected, and an area of the first connecting surface is smaller than an area of the second connecting surface,
wherein the second connecting pattern has a second gradual structure, a third connecting surface is formed at a position where the second gradual structure and the second coil pattern are connected, a fourth connecting surface is formed at a position where the second gradual structure and the second external electrode are connected, and an area of the third connecting surface is smaller than an area of the fourth connecting surface.

5. The vertically-wound inductor according to claim 4, wherein the first coil portion further includes a first dummy connecting pattern connected to the second external electrode, the second coil portion further includes a second dummy connecting pattern connected to the first external electrode, a first vertical projection of the first dummy connecting pattern formed onto the intermediate layer overlaps with a second vertical projection of the second connecting pattern formed onto the intermediate layer, and a third vertical projection of the second dummy connecting pattern formed onto the intermediate layer overlaps with a fourth vertical projection of the first connecting pattern formed onto the intermediate layer.

6. The vertically-wound inductor according to claim 3, wherein the first tangential direction is parallel to the second tangential direction, and the first tangential direction and the second tangential direction are perpendicular to the outer surface of the inductor body.

7. The vertically-wound inductor according to claim 6, wherein the intermediate layer has an enclosed ring that completely covers the first vortex coil and the second vortex coil.

8. The vertically-wound inductor according to claim 7, wherein the first vortex coil has a first hollow portion, the second vortex coil has a second hollow portion, and the intermediate layer has a hollow part corresponding to the first hollow portion and the second hollow portion.

9. The vertically-wound inductor according to claim 1, wherein the intermediate layer is made of a non-conductive material, and the non-conductive material includes at least one of an organic material containing oxygen and silicon functional groups, an epoxy resin, a polyimide (PI), a glass fiber material, and a ceramic material.

10. The vertically-wound inductor according to claim 2, wherein one end of the first coil pattern connected to the first external electrode has a first outer edge, and the first outer edge is separated from a first edge of the outer surface by a first predetermined length; one end of the second coil pattern connected to the second external electrode has a second outer edge, and the second outer edge is separated from a second edge of the outer surface by a second predetermined length; and the first external electrode and the second external electrode have a predetermined width, and the first predetermined length and the second predetermined length range from 0% to 50% of the predetermined width.

11. The vertically-wound inductor according to claim 5, wherein the coil further includes at least one third coil portion and at least one fourth coil portion disposed between the first coil portion and the second coil portion, the at least one third coil portion and the at least one fourth coil portion are disposed in the inductor body and are opposite to one another, and a second gap is formed between the at least one third coil portion and the at least one fourth coil portion.

12. The vertically-wound inductor according to claim 11, wherein two of the at least one third coil portion and the at least one fourth coil portion are connected through a guide bonding portion disposed at a side of the coil.

13. The vertically-wound inductor according to claim 12, wherein the intermediate layer is provided with another through hole, the at least one third coil portion and the at least one fourth coil portion are disposed in the intermediate layer, the first coil portion is connected to one of the at least one third coil portion through the connecting part penetrating the through hole, the second coil portion is connected to one of the at least one fourth coil portion through another connecting part penetrating the another through hole.

14. The vertically-wound inductor according to claim 13, wherein the guide bonding portion is disposed in the intermediate layer.

15. The vertically-wound inductor according to claim 14, wherein each of the at least one third coil portion is patterned as a third vortex coil, and each of the at least one fourth coil portion is patterned as a fourth vortex coil, and the intermediate layer has an enclosed ring that completely covers the first vortex coil, the second vortex coil, the third vortex coil and the fourth vortex coil.

16. The vertically-wound inductor according to claim 15, wherein the first vortex coil has a first hollow portion, the second vortex coil has a second hollow portion, the third vortex coil has a third hollow portion, the fourth vortex coil has a fourth hollow portion, and the intermediate layer has a hollow part corresponding to the first hollow portion, the second hollow portion, the third hollow portion and the fourth hollow portion.

17. The vertically-wound inductor according to claim 16, wherein the first vortex coil is separated from the at least one third coil portion by a third gap, and the second vortex coil is separated from the at least one fourth coil portion by a fourth gap.

18. The vertically-wound inductor according to claim 17, wherein the third gap and the fourth gap are filled by the intermediate layer.

19. The vertically-wound inductor according to claim 18, wherein the intermediate layer is made of a non-conductive material, and the non-conductive material includes at least one of an organic material containing oxygen and silicon functional groups, an epoxy resin, a polyimide (PI), a glass fiber material, and a ceramic material.

20. The vertically-wound inductor according to claim 19, wherein one end of the first coil pattern connected to the first external electrode has a first outer edge, and the first outer edge is separated from a first edge of the outer surface by a first predetermined length; one end of the second coil pattern connected to the second external electrode has a second outer edge, and the second outer edge is separated from a second edge of the outer surface by a second predetermined length; and the first external electrode and the second external electrode have a predetermined width, and the first predetermined length and the second predetermined length range from 0% to 50% of the predetermined width.
